(19) United States
(12) Patent Application Publication
(10) Pub. No.: US 2008/0007570 A1
(43) Pub. Date: Jan. 10, 2008

(54) Digital Content Playback

(76) Inventors: James Abram Wessel, Seattle, WA (US); Chris Brown, Manhattan Beach, CA (US)

Correspondence Address: FISH & RICHARDSON, PC, P.O. BOX 1022, MINNEAPOLIS, MN, 55440-1022, US

(21) Appl. No.: 11/769,607

(22) Filed: Jun. 27, 2007

Related U.S. Application Data
(60) Provisional application No. 60/817,022, filed on Jun. 27, 2006.

(51) Int. Cl. G09G 5/00

(52) U.S. Cl. 345/661

(57) ABSTRACT

Among other things, methods, systems and computer program products for enhancing a viewing experience of digital content includes displaying a predetermined sequence of multiple introductory digital content. The predetermined sequence minimizes a time delay before a main digital content is displayed. In addition, a graphical user interface can be loaded during a time of displaying a first introductory digital content from the predetermined sequence of multiple introductory digital content. User access of the loaded graphical user interface is enabled while the playing of the predetermined sequence of multiple introductory digital content is pending.

### CLAIM OF PRIORITY

This application claims priority under 35 USC §119(e) to U.S. patent application Ser. No. 60/817,022, filed on Jun. 27, 2006, the entire contents of which are hereby incorporated by reference.

### TECHNICAL FIELD

The subject matter described herein relates to techniques for presenting digital multimedia content to a user. For example, techniques may be implemented to facilitate a user's viewing of digital multimedia content stored on a digital video disc (DVD).

### BACKGROUND

Digital content (e.g., a movie) stored on a media disc (e.g., DVD) can be displayed using a media player (e.g., a DVD player). Typically, before the main digital content (e.g., the movie itself) is displayed, a sequence of introductory digital content (e.g., trailers, commercials. Etc.) are displayed.

### SUMMARY

In general, digital multimedia content, such as a movie recorded on a digital video disc (DVD), tend not to be designed to maximize the viewing enjoyment of a user. For example, when a DVD is inserted into a DVD player, a user often is locked out from interacting with the digital media content stored on the DVD until a static menu appears. Thus, the user is often forced to sit through a lengthy sequence of introductory materials (e.g., trailers, the FBI warning, commercials) before being able to access the static menu to start playing the movie.

In addition, the static menu tend not to be designed to facilitate user navigation of the digital multimedia content recorded on the DVD efficiently. In general, a lengthy sequence of button presses are required to navigate through the digital multimedia content, which may frustrate the user and dramatically reduce the quality of the viewing experience. Further, little or no assistance or guidance may be provided, and thus the user may be left to his own imagination as to which buttons he/she must activate to obtain a desired result.

In software accompanying a DVD containing a movie and related content, typically a scene browsing interface is provided. The browser interface tend to allow a user to browse to discrete entry points of the movie. Typically, the discrete entry points are concomitant with the beginning of each scene of a movie.

The standard scene browser typically consists of several pages, each page displaying several icons, or thumbnail images, in fixed positions. Each thumbnail image is typically a still screen shot representing a scene within the movie. Each still screen shot is typically the first frame of the scene or a memorable frame from within the scene.

In some standard scene browsers, page one of the scene browser may show icons for scenes one through five; page two may show icons for scenes six through ten; page three may show icons for scenes eleven through fifteen; and so on. A current selection, or “focus,” is sometimes denoted by a movable arrow. Focus is typically moved using arrow keys on a DVD player remote control. By pressing enter or play on the remote control, a scene which has the focus starts playing. This page scheme may make the interface simple to program by a DVD editing/publishing studio, but may not be designed to optimize the viewing experience of a user.

The present specification describes systems, methods and computer program products for enabling user control during the viewing of digital content.

In one aspect, enable user control during viewing of digital content includes displaying a predetermined sequence of multiple introductory digital content. The predetermined sequence minimizes a delay before a main digital content is displayed. Also, a graphical user interface is loaded during a time of displaying a first introductory digital content from the predetermined sequence of the multiple introductory digital content. Further, user access to the loaded graphical user interface is enabled while the displaying of the predetermined sequence of the multiple introductory digital content is pending.

Implementations can optionally include one or more of the following features. Displaying the main digital content can include displaying a movie. Also, displaying the plurality of introductory digital content can include displaying two or more selected from a group including a studio identification trailer, a movie trailer, a commercial, and a copyright warning message. Displaying the predetermined sequence of the multiple introductory digital content can further include displaying a predetermined sequence of a plurality of introductory digital content stored on a machine readable medium. Alternatively, displaying the predetermined sequence of the multiple introductory digital content stored on the machine readable medium can include displaying a predetermined sequence of multiple introductory digital content stored on one chosen from a group that includes a Blu-ray disc (BD), a digital video disc (DVD) and a high definition DVD disc (HD DVD). Further, displaying the main digital content can include automatically displaying the main digital content without a user interaction and while the displaying of the multiple introductory digital content is pending. Also, enabling the user to access the loaded graphical user interface can include enabling the user to start displaying the main digital content while the displaying of the predetermined sequence of the multiple introductory digital content is pending. Displaying the predetermined sequence of multiple introductory content can further include displaying a help tutorial to the user. Further, enabling the user to access the loaded graphical user interface while the displaying of the predetermined sequence of the multiple introductory digital content is pending includes enabling the user to access the loaded graphical user interface before completing the displaying of the predetermined sequence of the multiple introductory digital content.

In another aspect, a computer program product, embodied on a machine readable medium is designed to cause a data processing apparatus to perform operations including displaying a predetermined sequence of a plurality of introductory digital content. The predetermined sequence minimizes a delay before a main digital content is displayed. The computer program product also causes the data processing apparatus to load a graphical user interface during a time of displaying a first introductory digital content from the predetermined sequence of multiple introductory digital content. The computer program product further causes a data processing apparatus to enable a user to access the loaded graphical user interface while the displaying of the predetermined sequence of the multiple introductory digital content is pending.

In another aspect, a system includes a user interface, and one or more data processing devices designed to display a graphical user interface for enabling a user navigation of multiple digital content. The graphical user interface includes a first display area displaying a visual representation of multiple user input functions. The visual representation is designed to provide guidance to a user for each of the available input functions. The graphical user interface includes a second display area that displays a visual representation of a result of a user selection of one or more of the available user input functions. A user selection of one of the available user input functions changes the visual representation in the first display area.

Implementations can optionally include one or more of the following features. The first display area can be designed to activate and deactivate in response to a user request.

In another aspect, a system includes a user interface, and one or more data processing devices designed to display a graphical user interface. The graphical user interface includes a content display region that includes two or more display positions. Each display position is designed to display a visual representation of an ordered sequence of digital content scrolled through the display positions In addition, one of the display positions is further designed to enable user selection of one of the ordered sequence of digital content.

Implementations can optionally include one or more of the following features. The ordered sequence of digital content can include an ordered sequence of movie scenes, television series episodes, music tracks, or any segmented array of digital content. Also, the visual representation of the ordered sequence of digital content can be arranged in a loop. The display positions can further be designed to display the visual representation of the ordered sequence of digital content scrolled through the display positions in a forward direction and a reverse direction. In addition, the content display region can further include a range selector designed to enable user selection of a range of the ordered sequence of digital content displayed.

In another aspect, a method includes displaying a visual representation of an ordered sequence of digital content scrolled through multiple display positions. The displaying includes displaying a visual representation of a first one of the ordered sequence in a first display position. In addition, displaying also includes displaying a visual representation of a second one of the ordered sequence in a second display position. Further, displaying also includes displaying a visual representation of a third one of the ordered sequence in a third display position. The second display position is located between the first and third display positions. When a desired one of the ordered sequence of digital content is displayed in the second display position, a user selection of the digital content displayed in the second display position is enabled. Alternatively, when the desired one of the ordered sequence of digital content is displayed in the first display position, the ordered sequence is scrolled in a forward direction by relocating the visual representation of the second one of the ordered sequence of digital content from the second display position to the third display position, and relocating the visual representation of the first one of the ordered sequence of digital content from the first display position to the second display position. Alternatively, when the desired one of the ordered sequence of digital content is displayed in the third display position, the ordered sequence is scrolled in a reverse direction by relocating the visual representation of the second one of the ordered sequence of digital content from the second display position to the first display position, and relocating the visual representation of the third one of the ordered digital content from the third display position to the second display position.

In another aspect, a system includes a user interface, and one or more data processing devices configured to display a graphical user interface that includes a search category display area designed to display a plurality of user selectable search categories. The graphical user interface also includes a search input area designed to receive user input corresponding to a user selected search category. The graphical user interface further includes a search results display area designed to display one or more search results based on the received user input. The displayed search results are dynamically modified in response to the received user input. Further, the graphical user interface includes a content display area designed to display a visual representation of one or more digital content corresponding to one of the displayed search results.

Implementations can optionally include one or more of the following features. The displayed graphical user interface can further include a help display area operable to provide guidance to a user. Also, the user selectable search categories can include two or more selected from a group that includes actors, characters, dialogue, locations, spelling, objects, house, places and time. The user selected category can be displayed using a visual indication different from non-selected categories. The search input area can further include a selector that enables a user to access one of a keypad and an alphanumeric pad. In addition, at least one of the keypad and the alphanumeric pad is designed to provide predictive typing.

In another aspect, a system includes a user interface and one or more data processing devices designed to display a graphical user interface that includes multiple user selectable elements. The graphical user interface also includes multiple status indicators displayed adjacent to the plurality of user selectable elements. Each of the status indicators are dynamically modified based on a user selection of one of the user selectable elements.

Implementations can include one or more of the following features. The status indicators can be displayed using one or more natural language terms.

In another aspect, user control of digital content stored on a machine readable medium can be facilitated by playing a predetermined sequence of multiple introductory digital content. The predetermined sequence minimizes a time delay before a main digital content is played. In addition, a graphical user interface can be loaded during a play time of a first introductory digital content from the predetermined sequence of multiple introductory digital content. In response to a user selection of a first element on a remote control unit, a user may be provided with the loaded graphical user interface at any time during the playing of the predetermined sequence of multiple introductory digital content.

Implementations can include one or more of the following features. For example, the main digital content may be a movie. In addition, the multiple introductory digital content may include a studio identification trailer, a movie trailer a commercial, and a copyright warning message. Also, the machine readable medium may be any encoded digital file including those stored on a digital video disc (DVD), a Blu-ray disc (BD), or a high definition digital video disc (HD-DVD). Further, the main digital content may be automatically played, without a user interaction, after the multiple introductory digital content finish playing. In addition, providing the loaded graphical user interface further includes proving a user selectable element to allow the user to start playing the main digital content at any time. Playing the predetermined sequence of the multiple introductory content further includes playing a help tutorial to educate the user.

In another aspect, a graphical user interface for facilitating a user navigation of a digital content can include a first display area displaying a visual representation of a plurality of input elements located on a remote control unit. The visual representation may provide guidance to a user. In addition, the visual representation may include a mapping of the plurality of input elements to a plurality of input functions. Further, the plurality of input elements may be selectively mapped to the plurality of input elements based on a highlighted user selectable element displayed on a second display area.

In implementations, the graphical user interface may include one or more of the following features. For example, the first display area is configured to activate and deactivate in response to a user selection of a first input element of the multiple input elements. Also, the graphical user interface may further include a local selector configured to browse a list of related digital content. The local selector may include a plurality of display positions. The plurality of display positions includes a centrally located display position. Further a visual representation of the list of related digital content is scrolled through the centrally located display position. The list of related digital content includes a list of movie scenes.

In implementations, the graphical user interface may further include one or more of the following features. For example, the visual representation of the list of related digital content may be scrolled through the centrally located display position in a loop. The visual representation of the list of related digital content may be scrolled in a forward and a reverse direction. In addition, the graphical user interface may further include a range selector.

In another aspect, scenes (e.g., of a movie or other digital media content) may be browsed by displaying a local selector. The local selector may include a plurality of display positions. Further, the plurality of display positions may include a lowest position located at a first end, a highest position located at a second end, and a highlighted position located between the lowest position and highest position. Browsing the scene can also include displaying a k-minus-ith icon in the lowest position, a kth icon in the highlighted position, and a k-plus-ith icon in the highest position. If there are more than three positions, other icons may be displayed in the other positions. Further, browsing the scenes may include scrolling the local selector, wherein the scrolling includes deleting the k-minus-ith icon from the lowest position. The scrolling may also include moving the kth icon to a position adjacent to the highlighted position. In addition, the scrolling may include moving an icon which is adjacent to the highlighted position and opposite the position to which the kth icon is moved into the highlighted position. Further, the scrolling can include moving the k-plus-ith icon to a position adjacent to the highest position. Browsing the scene can also include displaying a new icon in the highest position.

In implementations, one or more of the following features may be included. For example, a range selector may be displayed, wherein the range selector includes a page down selector and a page up selector. In addition, the page up selector can be scrolled. Scrolling the page up selector can include deleting the k-minus-ith icon, the kth icon, and the k-plus-ith icon. Scrolling the page up selector can also include displaying a k-plus-ith-plus-oneth icon in the lowest position, a k-plus-two-ith-plus-oneth icon in the highlighted position, and a k-plus-three-ith-plus-oneth icon in the highest position. Also, the range selector may further include a current range indicator. The implementations can additionally include initiating the scrolling by a remote control unit. Each icon may be a picture of a scene in a cinematographic work, and each icon may represent an entry point in a cinematographic work. Further, a first scene of the cinematographic work and a last scene of the cinematographic work may be displayed in adjacent positions, and scrolling the local selector may treat the first scene and the last scene as chronologically ordered. Also, an icon in the highlighted position may be larger than icons in the other display positions.

In another aspect, a graphical user interface (GUI) for searching multiple digital media content may include a plurality of user selectable search categories. The GUI may include a search input window to receive user input. The GUI may further include a neighboring term display area to dynamically display a list of related terms based on the user input. Also, the GUI may include a help display window and a search results window.

In another aspect, a graphical user interface for providing a visual indication of available user selections may include multiple user selectable elements and multiple status indicators displayed adjacent to the user selectable elements. Each of the status indicators change based on a new status of a corresponding user selectable element.

Implementations may include one or more of the following features. For example, the status indicators may include natural language terms.

Further, the techniques can be implemented as a machine readable medium storing instructions operable to cause data processing apparatus to transfer a digital data file to a mobile communication device.

These aspects may be implemented using an apparatus, a method, a system, or any combination of an apparatus, methods, and systems. The details of one or more implementations are set forth in the accompanying drawings and the description below. Further features, aspects, and advantages will become apparent from the description, the drawings, and the claims.

### BRIEF DESCRIPTION OF DRAWINGS

FIG. 1A is a block diagram of a startup sequence.

FIG. 1B is a detailed block diagram of an introduction.

FIG. 1C is a screen shot of a startup sequence.

FIG. 2 is a flow chart of a startup sequence.

FIG. 3A is a screen shot of a GUI for browsing scenes.

FIG. 3B is a detailed diagram of GUI elements under a BROWSE tab.

FIG. 4 is a flow chart for browsing scenes.

FIG. 5 is a block diagram of a list of series of scenes.

FIG. 6 is a diagram of a local selector in operation.

FIG. 7A is a screen shot of a GUI including a key map.

FIG. 7B is a detailed view of a key map.

FIG. 7C is a screen shot of a key map in operation.

FIG. 8 is a screen shot of a SETTINGS tab.

FIG. 9 is a screen shot of a SEARCH tab.

FIGS. 10a, 10b, 10c and 10d are screen shots illustrating SEARCH functions.

Like reference symbols in the various drawings indicate like elements.

### DETAILED DESCRIPTION

The following describes techniques for facilitating user control and navigation of a digital multimedia content stored on a machine readable medium. While the forgoing describes presenting to a user a movie recorded on a DVD, a Blu-ray disc (BD), or a high definition DVD (HD-DVD), the techniques are applicable for presenting other suitable digital content. In addition, because the techniques presented are not format specific, the storage medium and the recording format is not limited to a DVD, a BD, or a HD-DVD.

Startup Sequence Standard

In general, when a user inserts a DVD into a dedicated player, a startup sequence is automatically initiated. The startup sequence includes playback of a series of introductory digital content that may include a movie studio identification (ID) trailer, one or more movie trailers, one or more commercials, one or more legal notices (e.g., an FBI warning on copyright law and consequence of violating the copyright law), and a static menu. These introductory digital content, whether all of the above or only some are played, are automatically played one by one in a predetermined sequence, and user interaction during this time is not permitted. Any attempts by the user to input a command by press a button on a remote control unit often is not recognized by the dedicated player, and in some instances, an icon is displayed to indicate that a user input is not permitted at this time. Therefore, a user is unable to interrupt the playback of the startup digital content and must wait till the entire content of the startup sequence has played out. Typically, the startup content and the sequence of playback are predetermined by the movie studio with little or no regard to the viewing enjoyment of the user.

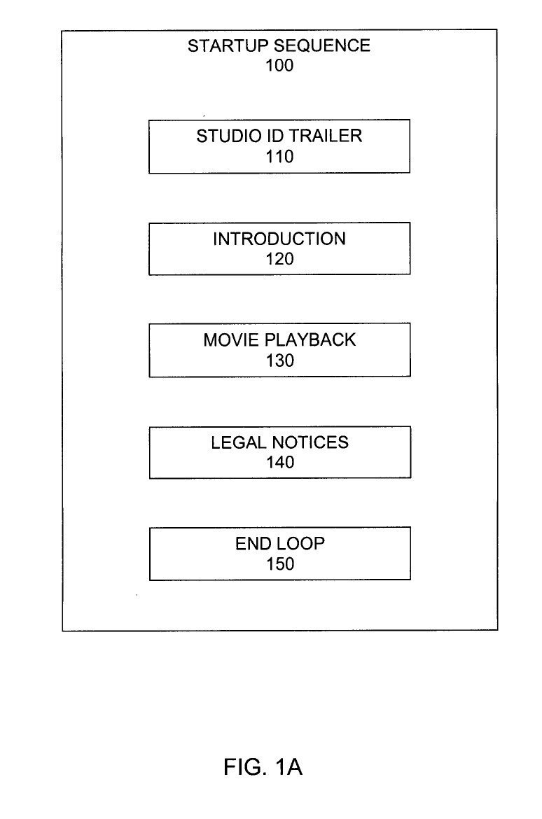

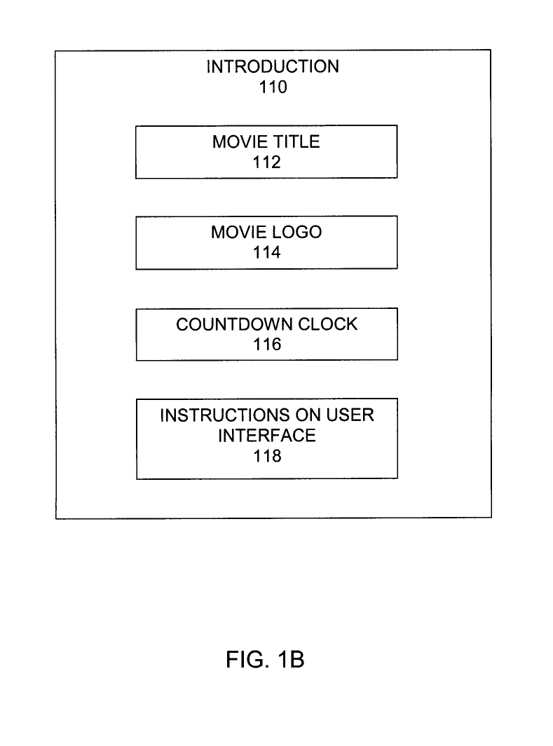

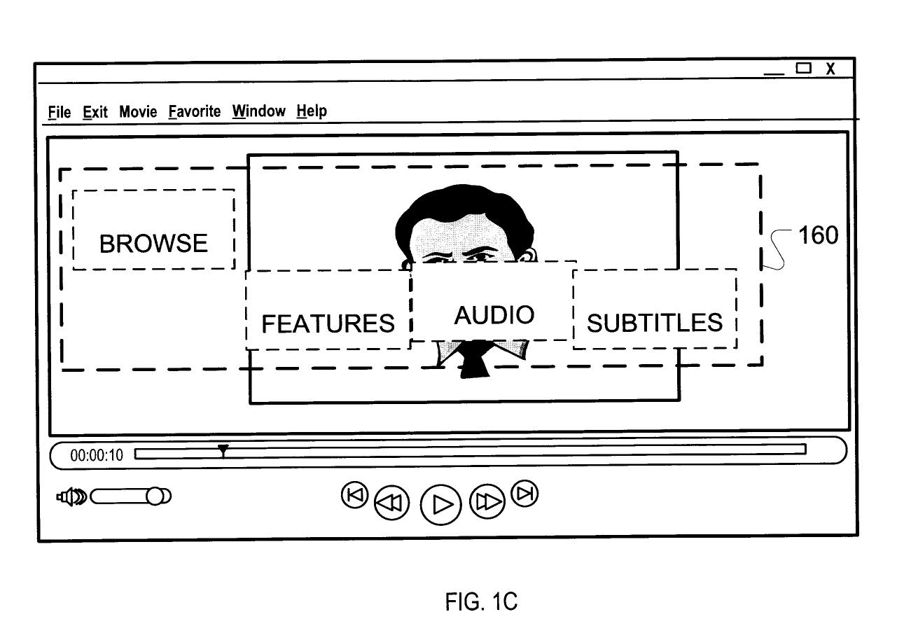

FIG. 1A illustrates a startup sequence 100 configured to minimize a time delay before a user is able to start playing the desired main content (e.g., the movie) recorded in a DVD. A particular order to the startup sequence is not limited to the one illustrated in FIG. 1, and other suitable orders that minimize the time delay before the start of the movie are also possible. The startup sequence 100 may include a studio ID trailer 110, an introduction 120, a movie playback 130, legal notices 140, and an end loop 150.

The studio ID trailer 110 may identify the creator, producer, and distributor of the movie, and the run time of the studio ID trailer may be limited by a predetermined time limit to minimize the time delay before the movie is played. While more than one studio ID trailer may be played, minimizing the number is preferred. The studio ID trailer playback may be limited by a predetermined sound level.

FIG. 1B is a detailed view of the introduction 120. The introduction 120 may include information (including graphical, textual, and audio) to identify the movie title. The information may include the movie's title 112, a movie logo 114, a countdown clock 116, and instructions on use of the user interface 118. The countdown clock 116 may be implemented as a numerical clock or a graphical clock (e.g. an hourglass). The countdown clock 116 may be used to display the time remaining before the movie playback begins. The countdown clock 116 may be displayed at a corner of the display screen so as to not interfere with other information currently displaying on the display screen. Alternatively, the countdown clock may be displayed at other suitable locations. In some implementations, the countdown clock can be turned on/off in response to the user activating a button on a remote control unit. The countdown clock 16 may be restricted in display size be a predetermined display size limit.

Instructions on graphical user interface 118 may include a combination of visual and audio instructions to familiarize the user with the user interface of the DVD. For example, during the playback of the introduction 120, the following voice-over message may be presented to the user.
“Welcome to your [high-definition Blu-Ray, high-definition HD-DVD, or standard-definition video] disk from [Producer]. Menus are always on call for easy access to scenes, settings, languages and special features. To show or hide menus during the feature presentation, press the [MENU or POP-UP] button on your remote control. Use the arrow buttons on your remote control to navigate the menus. Thank you and enjoy the show.”

FIG. 1C is a screen shot of an introduction 120 playing along with the above described voice over. During the voice-over, the corresponding graphical user interface (GUI) 160 being described by the voice-over, such as a menu is also displayed. The GUI may include multiple main menu elements or tabs, such as BROWSE, FEATURES, AUDIO, AND SUBTITLES. In addition, each main menu tab may include appropriate sub-menu elements (not shown) directed to user input functions relevant to each of the main menu elements. The introduction 120 may be limited by a predetermined time limit to minimize the time delay before the movie is played.

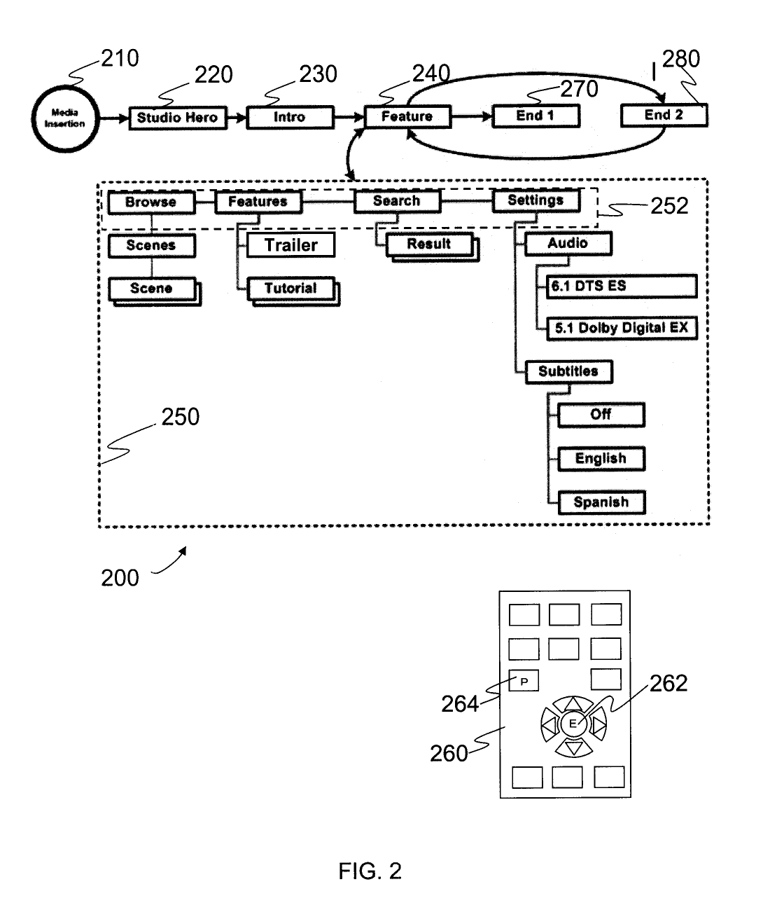

FIG. 2 is a flow chart 200 of the startup sequence 100. In operation, a user may begin by inserting a media 210 into a dedicated media player. The media may be a DVD, BD, or a HD-DVD. The startup sequence 100 automatically plays starting from a first startup (or introductory) content and transitions to the next startup content without delay and without a user interaction. The first startup content may be a studio hero 220 (a “hero” refers to studio identification content, such as the studio ID trailer 110). At the conclusion of the studio hero 220, an introduction 230 is automatically played without a user intervention. At the conclusion of the introduction 230, playback of the main digital content, such as a feature presentation (e.g., a movie) 240 is executed without a user intervention. This allows for a minimum delay time before the movie is played. In some implementations, the movie playback does not occur automatically, but a user interface element (not shown) mapped to executing the movie playback is automatically highlighted at the conclusion of the introduction 230. In such implementations, a single selection of a first button 262 on a remote control unit 260 by the user executes playback of the feature presentation 240. The remote control unit 230 includes standard remote controllers and other data processing devices such as a mobile phone, a smart phone, a PDA, a laptop computer, an MP3 player, a game console controller, etc.

At any time during the startup sequence 100 playback, the user is able to access a graphical user interface (GUI) 250 by selecting a second button 264 on the remote control unit. In other words, while the ordered sequence of introductory digital content is pending, a user is able to access the GUI 250. The second button may be labeled “POP-UP” or “MENU” on a standard remote controller for a DVD, BD, or HD-DVD player. Accessing the GUI 250 can allow the user to opt out or skip any of the startup (introductory) content in the startup sequence 100. In addition, accessing the GUI 250 provides an instant access to any available digital content stored on the media 210. A desired digital content is accessed by selecting one of the main menu elements 252 (e.g., BROWSE, FEATURES, SEARCH, and SETTINGS). For example, selecting the BROWSE element allows the user to browse through the available scenes and to select a desired scene.

Access to the GUI 250 is provided not only at any time during the startup sequence 100, but also at any time while the media 210 is being played through the dedicated media player (i.e., while displaying of the introductory digital content is pending.) This means that as soon as the first image appears after the media 210 is inserted into the dedicated player, the GUI 250 is loaded into the dedicated player's memory, such as a random access memory (RAM) or any other suitable memory storage. The GUI 250 is loaded within a predetermined time, which is no longer than a time required to play the first startup content, such as the studio hero 230. As soon as the GUI 250 is loaded, the user is able to access the GUI 250 by a single selection of the second button 264 on the remote control unit 260. Therefore, the user is able to opt out of all of the startup (introductory) digital content including the studio hero 220, and the introduction 230.

The GUI 250 may be implemented as a “dashboard” that is always accessible with a single touch of a button on a remote control unit 260, but hidden from view until the user calls on the GUI 250 or a need arises for the GUI 250. For example, in some implementations, at the conclusion of the feature presentation 240, a first end 270 of the media playback is automatically invoked without a user intervention. The first end 270 may call routines or instructions to play other digital content available, such as special features. In some implementations, a first end 270 executes a display of the feature presentation's graphic identity. The graphic identity may include a movie title, a movie icon, or other suitable data related to the movie.

In some implementations, the first end 270 invokes the GUI 250 for display. Once the GUI 250 is displayed, the user may interact with the GUI 250 to access one or more functions and/or digital content of the media.

In some implementations, at the conclusion of the feature presentation 240, a second end 280 executes the feature presentation 240 automatically, and the movie is played again. In such implementations, the movie play repeats in a loop until the user opts out by interacting with the GUI 250.

Browser Interface

In one aspect, an enhanced GUI is provided to facilitate a user navigation through the various scenes of a movie recorded on the media.

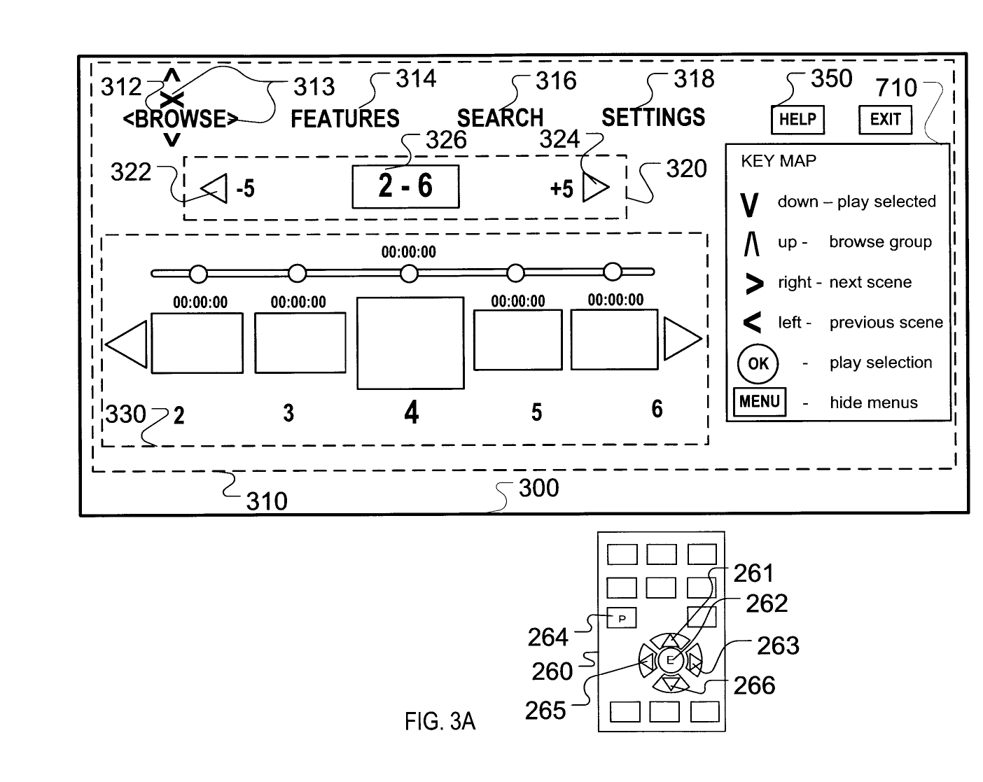

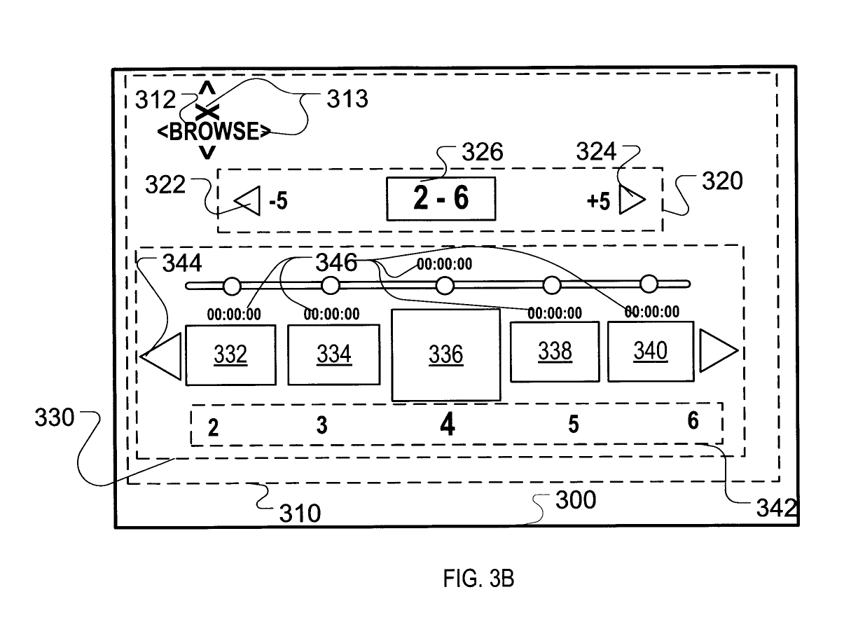

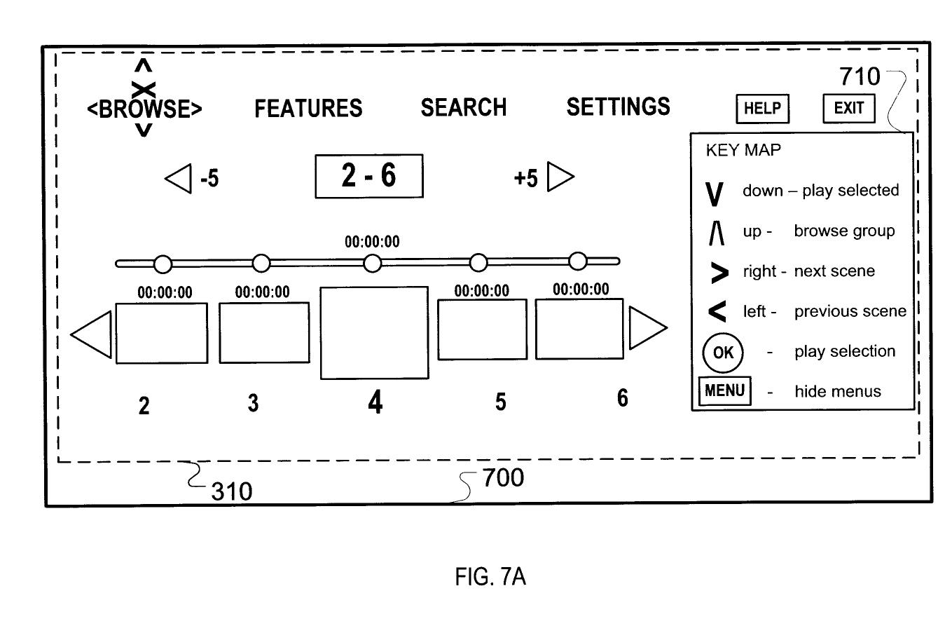

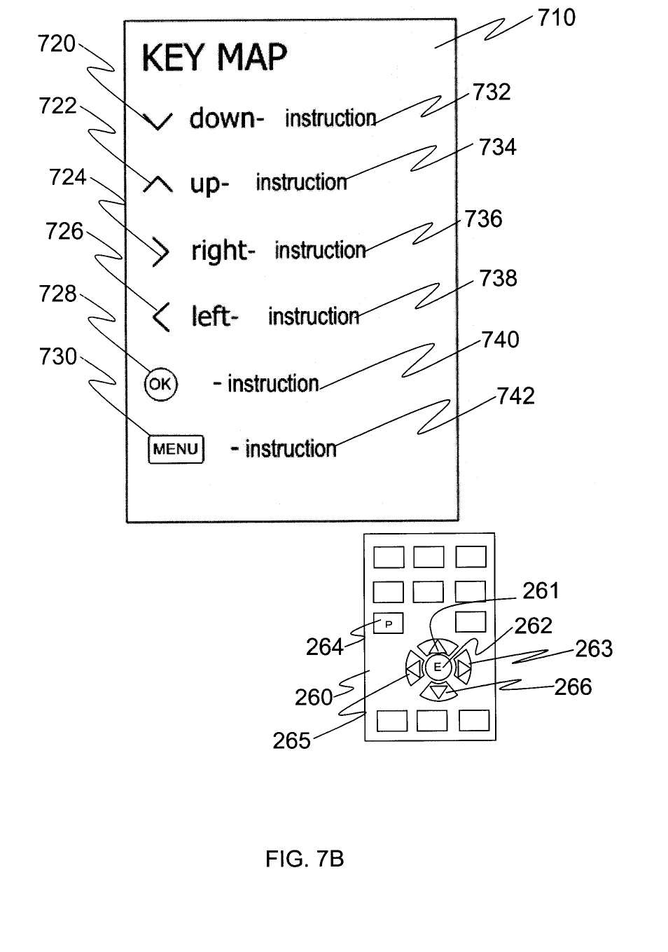

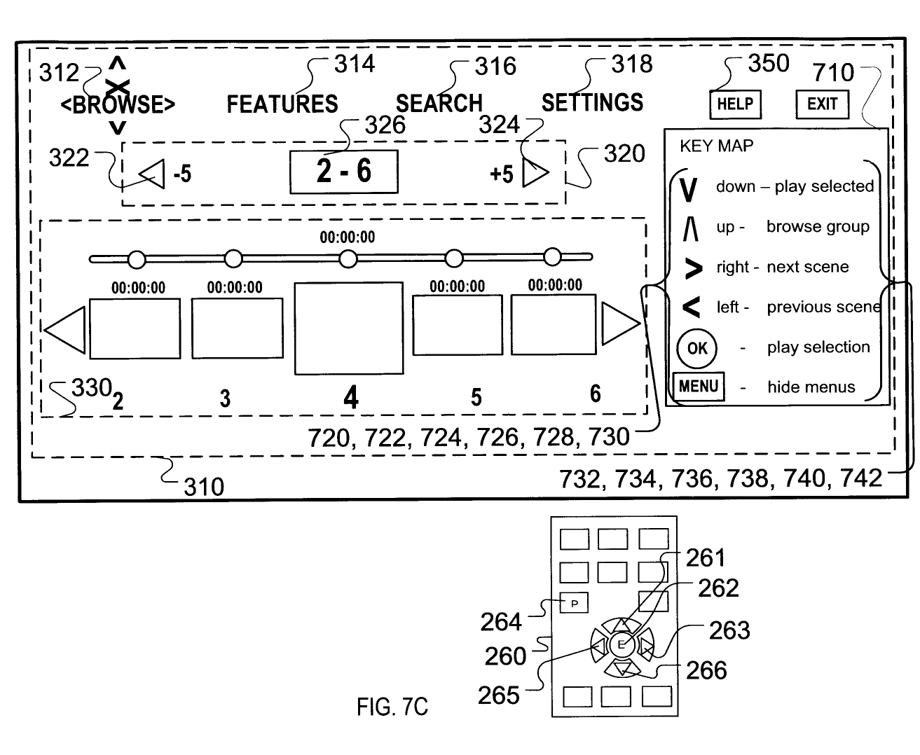

FIG. 3A shows a GUI 310 displayed on a display screen 300 for facilitating user interaction and navigation with the digital content of a media, such as a DVD. As described above, the GUI 310 may be activated and displayed to the user at any time in response to the user selecting a input selector 264 (e.g., labeled “POP UP” or “MENU”) on the remote control unit 260. The GUI 310 may include main GUI tabs labeled BROWSE 312, FEATURES 314, SEARCH 316, and SETTINGS 318. The GUI 310 may further include a help GUI element 350 and a key map 710 (described further below with respect to FIG. 7).

The main GUI tabs 312, 314, 316, 318 represent the main interactive input functions available to the user with each of the tabs 312, 314, 316, 318 providing additional sub input functions. For example, a user selection of the BROWSE tab 312 is indicated with a clear visual focus, such as a crosshair element 313. However, in some implementations, other unique visual focus may be implemented. To reduce the number of selector presses required by the user, a single input selector press automatically selects and activates the selected main GUI tab. For example, depending on the currently selected GUI element, a user selection of one of the directional selector elements 261, 263, 265, 266 on a remote control unit 260 automatically selects (indicated by a focus) and activates the desired main GUI tab to show all sub input functions available under the main GUI tab. This eliminates the need for the user to select one input selector to highlight the desired main GUI tab and a second input selector to activate the main GUI tab before being able to see the available sub input functions available under the selected main GUI tab.

FIG. 3A illustrates a user selection of the BROWSE tab 312. The BROWSE tab 312 further includes a range selector 320, and a local selector 330. FIG. 3B is a detail view of the BROWSE tab 312. The range selector 320 may further include a range increment element 324 (labeled “+5”) for increasing the range of scenes displayed to the user for the user's selection. The range increment element 324 may be implemented to increase by a predetermined range of scenes. The range selector 320 may also include a range decrement element 322 (labeled “−5”) for decreasing the range of scenes displayed to the user for the user's selection. The range decrement element 322 may be implemented to decrease by a predetermined range of scenes. The range selector may further include a range display 326 to provide a visual indication of the range selected.

FIG. 3B shows a detailed view of the local sector 330. The local selector 330 may include display positions 332, 334, 336, 338, and 340 representing each individual scene of a movie. An icon, an image or other suitable graphical representation may be implemented to represent a scene in the display positions 332, 334, 336, 338, and 340. The display position 336 represents the current user selection. The display position 336 is uniquely displayed to distinguish the user selected scene from the other available scenes. For example, FIG. 3B shows the display position 336 centered and in a larger size relative to the other display positions. However, in some implementations, other suitable visual indications may be implemented. Optionally, the scene browser may include GUI elements 343, 344 to indicate to the user the available input functions for scrolling forward or reverse by a single scene. Optionally, a scene time code indicator 346 for each display positions 332, 334, 336, 338, and 340 may be implemented. Non-selected scenes are located in display positions to the left 332, 334 and right 338, 340. In some implementations, other display locations may be implemented for the non-selected scenes relative to the selected scene. For example, the non-selected scenes may be displayed to the top and bottom (not depicted) of the selected position 314. The display positions 332, 334, 336, 338, and 340 may be arrayed in a grid, circular, or other geometric pattern, or merely arranged in a line as shown in FIGS. 3A-B.

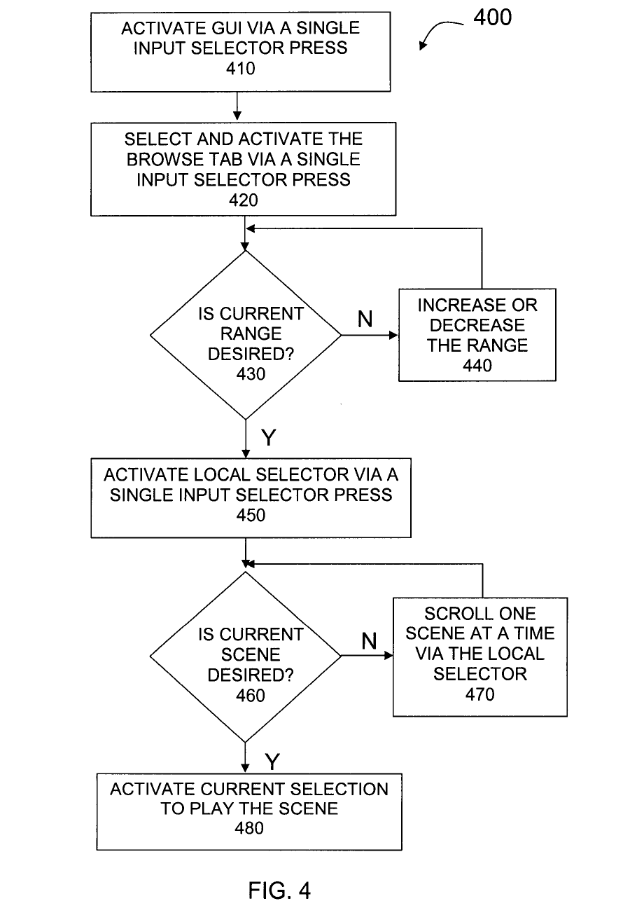

FIG. 4 is a flowchart of a process for navigating through a list of available scenes under the BROWSE tab 312. At any time desirable by the user, the user activates the GUI 310 via a single press of an input selector (e.g., input selector 264) on the remote control unit 260 at 410. To browse through a list of available movie scenes, the user selects the BROWSE tab 312 at 420, via a single press of an input selector (e.g., one of the directional input selectors 261, 263, 265, and 266 on the remote control unit 260). The user determines at 430 whether the currently selected range of scenes contains the desired movie scene. At 440, if the currently selected range does not include the desired scene, the user increases or decreases the range via a single press of an input selector on the remote control unit 260. For example, the user may press the left directional input selector 265 or the right directional input selector 263 on the remote control unit 260 to decrease or increase the range. If the currently selected range does include the desired scene, at 450, the user selects the local selector by a single press of an input selector on the remote control unit 260. For example, the down directional input selector 266 may be pressed. At 460, the user determines if the currently selected scene (as displayed in the highlighted display position 336) is the desired scene. If the currently selected scene is not the desired scene, the user scrolls, at 470, one scene at a time. The scrolling action may be actuated by pressing one of the directional input selectors 261, 263, 265, and 266 on the remote control unit 260. For example, the left directional input selector 265 may scroll the scenes in the reverse direction, and the right directional input selector 263 may scroll the scenes in the forward direction. When the desired scene has been selected, the user plays the selected scene via a single press of an input selector on the remote control unit 260.

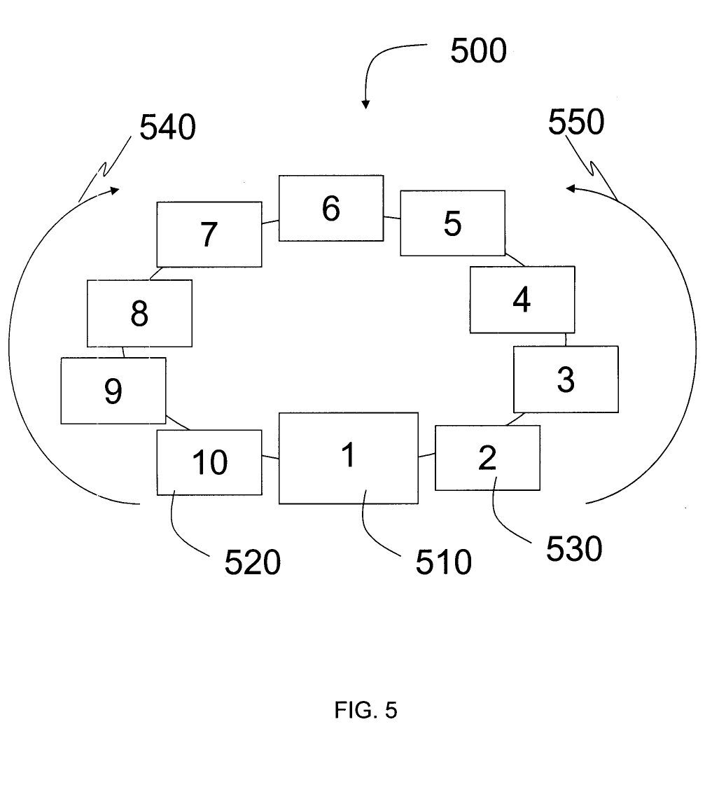

Scrolling in both the reverse and forward directions allows the user easily identify and play the desired scene. The scrolling action is facilitated by implementing the available scenes in a loop 500 as shown in FIG. 5. Ten hypothetical movie scenes are shown in FIG. 5 with the first scene (labeled “1”) displayed in a center, currently selected position 510. Displayed to the left of the first scene is the last scene (labeled “10”) 520. Displayed to the right of the first scene is the second scene (labeled “2”) 530. The user scrolls (via the local selector 330) in the forward direction 540 or the reverse direction 550 to select the desired scene.

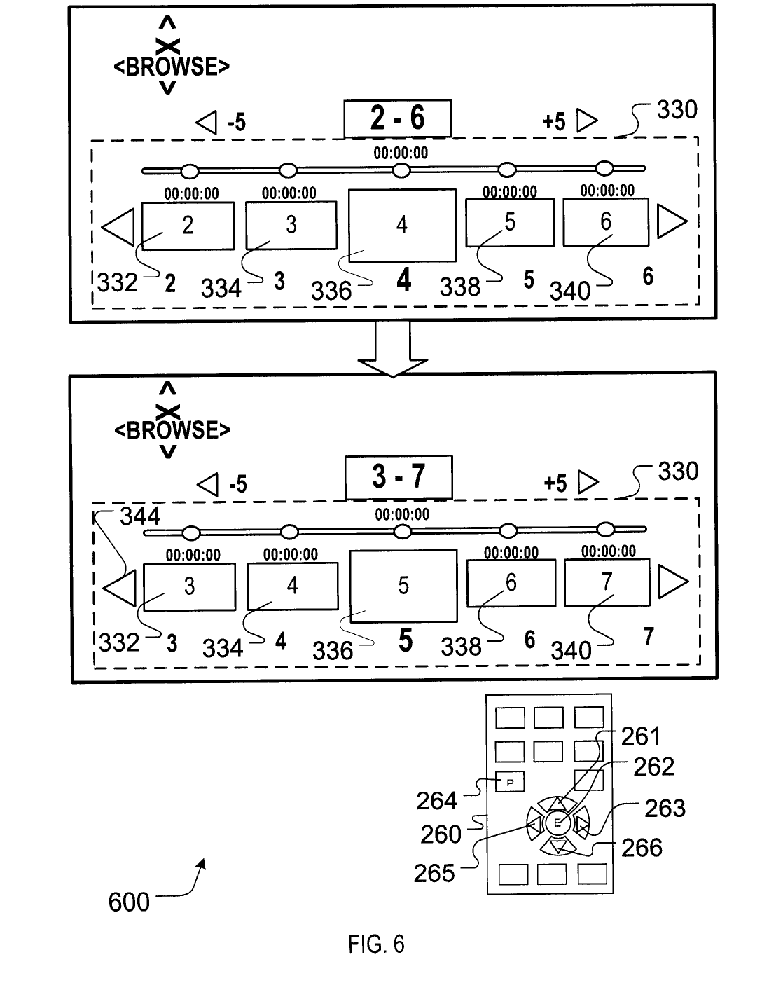

FIG. 6 illustrates a user interaction 600 with the local selector 330 to scroll through the available scenes. The top figure shows scenes 2 through 6 displayed with the fourth scene (labeled “4”) displayed in the currently selected display position 336. A user selection of one of the directional input selectors 261, 263, 265, and 266 on the remote control 260 scrolls the scenes displayed in the display positions 332, 334, 336, 338, and 340 either in a forward or a reverse direction. For example, when the user presses the right directional input selector 263, the scenes displayed in the display positions 332, 334, 336, 338, and 340 are redisplayed in new forwarded display positions as shown in the bottom figure. After the redisplay, the fifth scene (labeled “5”), which was previously displayed in the display position 338, located to the right of the highlighted position 336 appears in the highlighted display position 336. The fourth scene, which was previously displayed in the highlighted position 336 is redisplayed in the display position 334 located to the left of the highlighted display position 336 and opposite the display position 338. In addition, the second scene, which was previously displayed in the first display position 332 is deleted from the screen, and the third scene (labeled “3”) that was previously displayed in the display position 334 is displayed in the first display position 332. By pressing an input selector, such as the enter button 262 or play button (not depicted) on the remote control unit 260, the scene displayed in the highlighted display position 336 starts playing.

In some implementations, the redisplaying may involve an animation which moves each scene to a new display position.

Scrolling through the available scenes under the BROWSER tab 312 is intuitive and efficient. The currently selected scene is always displayed in the same display position 336; therefore, a user does not have to initially recognize the format of a selector or follow it around the screen as focus is changed. The user can concentrate his visual attention on one position on the screen, namely the currently selected (or highlighted) display position 336. The user may then concentrate his tactile senses to placing his finger on one of the directional input selector elements 261, 263, 265, and 266 on the remote control unit 260. Additionally, observers who are not in possession of the remote control unit 260 can better understand what input function is being selected. The observers can then better advise the user as to the desired movie scene.

In addition, the BROWSER tab 312 may be implemented to display the browser screen in a substantially constant format. Instead of browsing and changing the whole page in which all GUI elements and other graphics of the page might change, only a relatively confined row of GUI elements may need to be changed. This may lessen the annoyance of the user and observers studying the screen. Also, the number of keystrokes needed to select a desired scene is minimized. Further, a user need not move back and forth between a main menu (or a higher level menu) and a sub-menu to select different display pages.

While five display positions have been described, the total number of display positions may be varied. In some implementation, more than five display positions may be implemented. While in other implementations, less than five display positions (e.g., three display positions) may be implemented.

In addition, while the display positions have been arranged in a horizontal row, the display positions may be arranged in other suitable geometric formats. In some implementations, the display positions may be arranged in a two-dimensional grid. For example, the upper-left display position may be the lowest position, and the lower right display position may be the highest display position. The act of scrolling may cause each row of scenes to shift to the left. In such example, the left-most scene in each row moves to the right-most display position in the row immediately above it. The scene in the lowest display position is deleted, and a new scene appears in the highest display position. In other implementations, other suitable geometric and non-geometric shapes can also be used.

The term DVD as applied herein may include any mass-storage media, including, but not limited to, a hard disk, read-only memory (RAM), or other optical disk.

A movie as described herein may include cinematographic works and assimilated works expressed by a process analogous to cinematography.

The term, scene, as applied herein may include audio-visual elements not a part of the original movie, such as, but not limited to, special features, featurettes, deleted scenes, out-takes, director's cuts, alternate endings, movie trailers, trivia screens, previews, advertisements, related games, audio musical compositions, and executable applications.

Help System

To further enhance the viewing experience of the user, a dynamic help system provided to the user at all stages of the media playback. FIG. 7A is a screen shot 700 of a GUI 310 displayed and activated on a monitor. In one aspect of the help system, a key map 710 is provided as a component of the GUI 310. The key map 710 may provide a visual representation of all available input functions based on a currently selected GUI element on the GUI 310. The currently selected GUI element on the GUI 310 is visually indicated by giving focus to the selected GUI element.

FIG. 7B illustrates a detailed view of the key map 710. The key map 710 includes icons 720, 722, 724, 726, 728, and 730 representing input selectors 261, 262, 263, 264, 265, and 266 on the remote control unit 260. Each of the icons 720, 722, 724, 726, 728, and 730 corresponds to a particular input selector 261, 262, 263, 264, 265, or 266, and the key instructions 732, 734, 736, 738, 740, and 742 displayed adjacent to the icons 720, 722, 724, 726, 728, and 730 describe the corresponding input functions mapped to the input selectors 261, 262, 263, 264, 265, and 266 on the remote control unit 260. Based on a currently selected GUI element, the input selectors 261, 262, 263, 264, 265, and 266 on the remote control unit 260 are selectively mapped to different input functions.

FIG. 7C illustrates the dynamic qualities of the key map 710. For example, in response to the focus (or the user selection) being on the BROWSE 312 GUI element, the key map instructions 732, 734, 736, 738, 740, and 742 dynamically change to reflect a new mapping for the input selectors 261, 262, 263, 264, 265, and 266 to new input functions. For example, the key instruction 736 corresponding to the right directional icon 724 dynamically changes to indicate that the next main menu tab 314 (in this example, the FEATURES tab) will be selected. Also, the key instruction 732 corresponding to the down directional icon 720 dynamically changes to indicate that a range selector 320 will be selected.

In the above example, if the focus changes to the range selector 320 (via the user selecting the down directional input selector 266 on the remote control unit 260), the key map instructions 732, 734, 736, 738, 740, and 742 change to reflect a new mapping for the input selectors 261, 262, 263, 264, 265, and 266 to new input functions in response to the new focus. For example, the key instruction 736 corresponding to the right directional icon 724 dynamically changes to indicate that the “+5” range selector 322 will be selected and activated to increase the scene range by five scenes. Similarly, the key instruction 738 corresponding to the left directional icon 724 dynamically changes to indicate that the “−5” range selector 332 will be selected and activated to decrease the scene range by five scenes. The selection of either the “+5” or the “−5” range selectors will be accompanied by a corresponding change in the range display 326 and the local selector display positions 330.

To provide an additional freedom to the user to customize all aspect of the viewing experience, the key map display may be turned on/off by a simple selection of an input selector (not shown) on the remote control unit 260. In addition, the display location (while FIG. 7C illustrates the location at the right side of the screen) may be moved to any other suitable location, in response to a user interaction, to enhance the viewing experience of the user.

In some implementations, additional help may be provided to the user in response to a user selection of one or more GUI elements. For example, a “help” GUI element 350 may be implemented to provide instant access to a help menu (not shown) designed to provide helpful instructions relevant to interacting with the GUI elements and/or accessing a desired digital content. In addition, a fully interactive help tutorial may be implemented and accessible under one of the main menu tabs, such as the FEATURES tab 314. The help tutorial may include visual and/or audio aids such as images, videos, voice-overs, and graphics designed to teach the user to use all available GUI elements, navigate the media, and access the desired digital content.

Natural Language Selector

In another aspect, user interaction with GUI 310 to navigate through the available digital media content is further enhanced by implementing a natural language selection system.

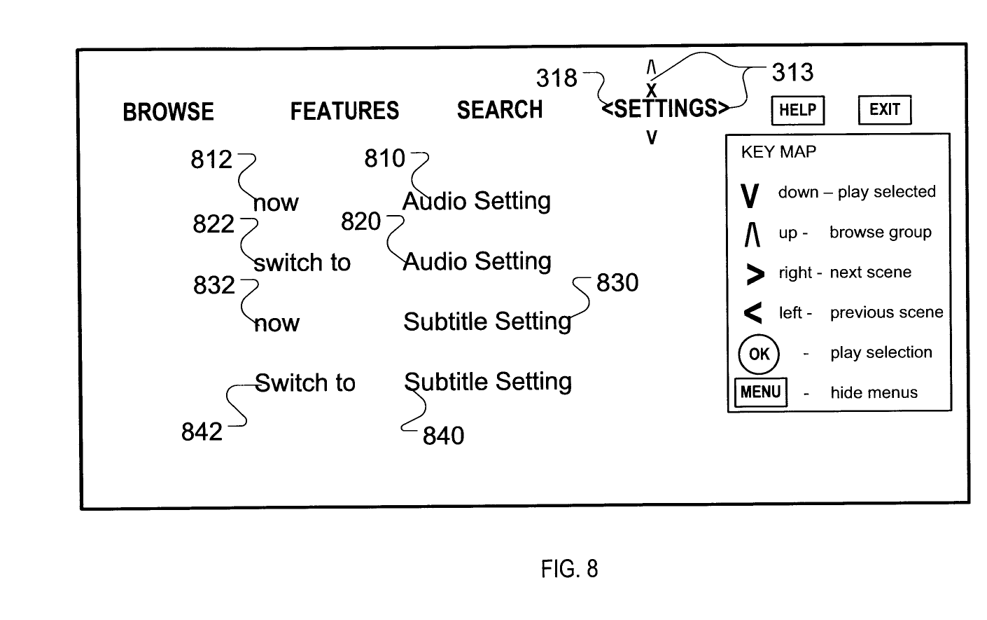

FIG. 8 is a screen shot of the SETTINGS tab 318. User selection of the SETTINGS tab is indicated at least by the crosshair 313 visual indicator. However, other suitable visual indications to indicate a focus on the GUI element may be implemented. While an implementation of the natural language is described with respect to the SETTINGS tab 318, the techniques can be implemented for all user selectable GUI elements. The SETTINGS tab 318 may include user selectable GUI elements to set various characteristics of the digital content (e.g., a movie). For example, audio settings 810, 820 and subtitle settings 830, 840 may be implemented. In addition, setting statuses 812, 822, 832, and 843 may also be displayed adjacent to the audio settings 810, 820, and the subtitle settings 830, 840.

With respect to the audio settings, a current audio status 812 is displayed to indicate that a first audio setting 810 displayed adjacent to the status 812 is the currently selected setting. A next audio status 822 is displayed to indicate that a second audio setting 820 displayed adjacent to the status 822 is an available setting selectable by the user.

With respect to the subtitle settings, a current subtitle status 832 is displayed to indicate that a first subtitle setting 830 displayed adjacent to the status 832 is the currently selected subtitle setting. A next subtitle status 842 is displayed to indicate that a second subtitle setting 840 displayed adjacent to the status 842 is an available setting selectable by the user.

The audio statuses 812, 822 and the subtitle statuses 832, 842 are displayed using natural language instead of graphics to facilitate user comprehension of the current and available selections. By using natural language indicators, the user does not have to remember the meaning of a graphical icon of an image. For example, currently selected settings 812, 832 may be displayed using a natural language label, “now.” The available settings 822, 842 may be displayed using a natural language label, “switch to.” In some implementations, other natural language labels may be implemented. For example, the current selection may be labeled, “current.”

While FIG. 8 illustrates only one “switch to” setting for each type of setting, the natural language selectors can be implemented for a multiple settings option. For example, if five subtitles are available (e.g., one for English, one for German, one for Japanese, one for French, and one for Spanish), one of the five settings can be labeled as “now” and the remaining as “switch to.”

Search

In another aspect, a system for facilitating a search for a digital content, both static and dynamic, is also implemented.

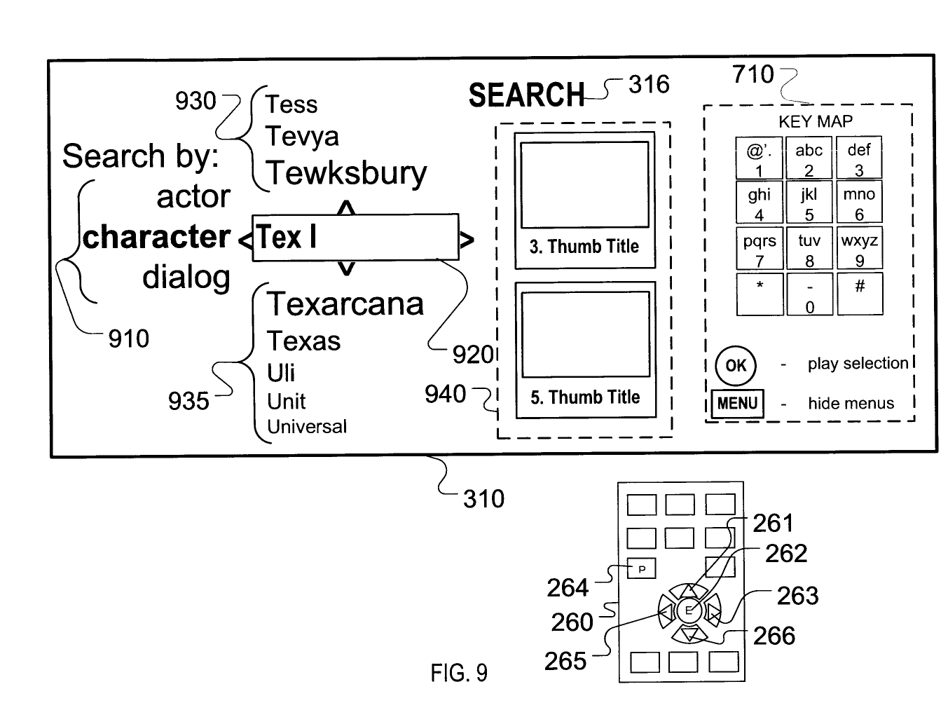

FIG. 9 is a screen shot of the GUI 310 displaying the SEARCH tab 316. The SEARCH tab 316 may be implemented to include GUI elements configured to facilitate a search for a desired digital content by a user. The SEARCH tab 316 may include a search category selector 910, a search input box 920, neighboring search term displays 930, 935, and a search result display 940. The SEARCH tab 316 may also include a key map 710.

A user may begin a search by first selecting a desired search category from the search category selector 910. The search category selector may include intuitive categories, such as “actor,” “character,” and “dialogue.” Other suitable categories may also be included (e.g., “director,” “producer”, etc.). FIG. 9 illustrates a user selection of “character” from the search category selector 910, which activates or highlights the search input box 920. The user may being entering a search term related to the category selected by pressing the appropriate input selectors on the remote control unit 260. The user is instructed on the appropriate input selectors to press by the key map 710.

As the user enters each letter of the desire term, related search terms automatically scrolls into view and are displayed on the neighboring search term display 930 and 935. For example, FIG. 9 shows a user entry of “Tex,” which automatically displays the available related terms in alphabetical order. Thus, “Tess,” “Tevya,” and “Tewksbury” are displayed in display 930, which is located above/before the search input box 920, and “Texarcana,” “Texas,” “Uli,” “Unit,” and “Universal” are displayed in display 935, which is located after/below the selection input box 920. The terms displayed in the neighboring search term displays 930 and 935 are pre-defined vocabulary of likely search terms. The pre-defined terms allows the user to find all available terms without having to enter all letters of the desired term. As soon as the desired term is displayed in the neighboring search term displays 930 and 935, the user may select the desired term by pressing one of the directional input selectors 261, 263, 265, and 266 to navigate to and select the desired term.

In some implementations, the most likely search may automatically be displayed in the search input box 920 before the user finishes entering all the letters of the desired term. In other implementations, other intuitive selection methods may be implemented.

In some implementations, the search may be expanded to cover searchable digital content located online.

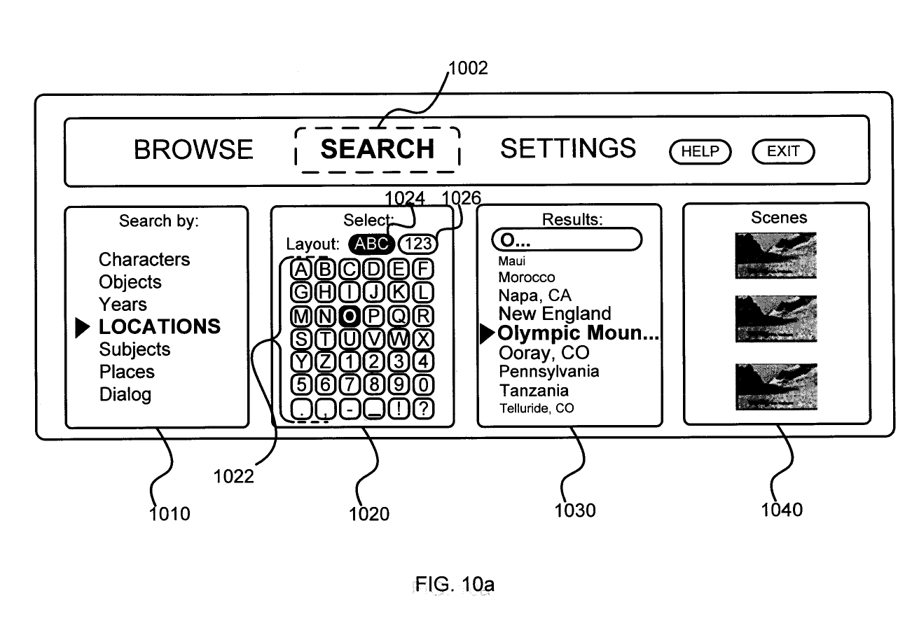

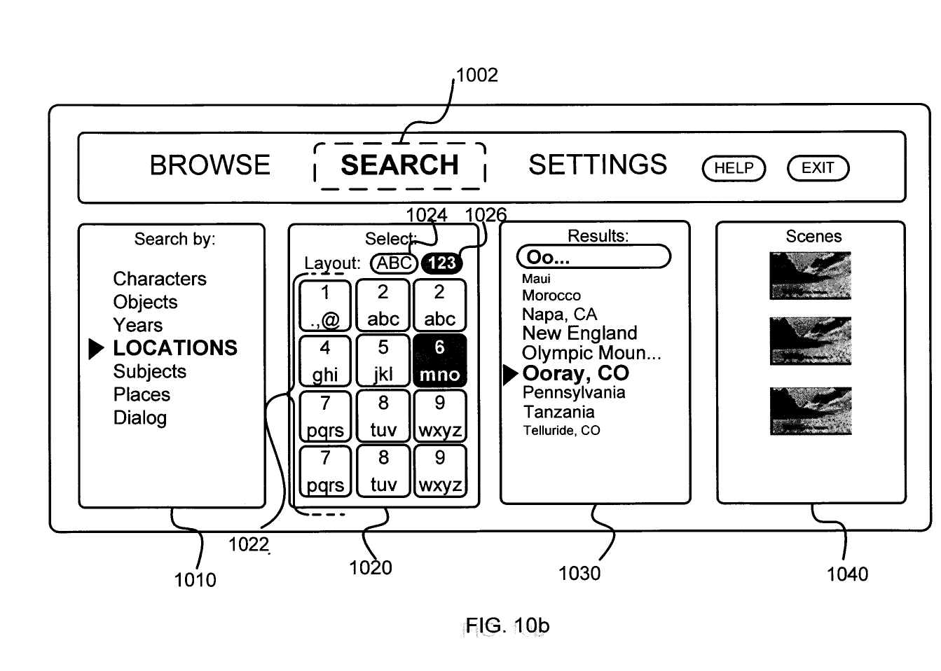

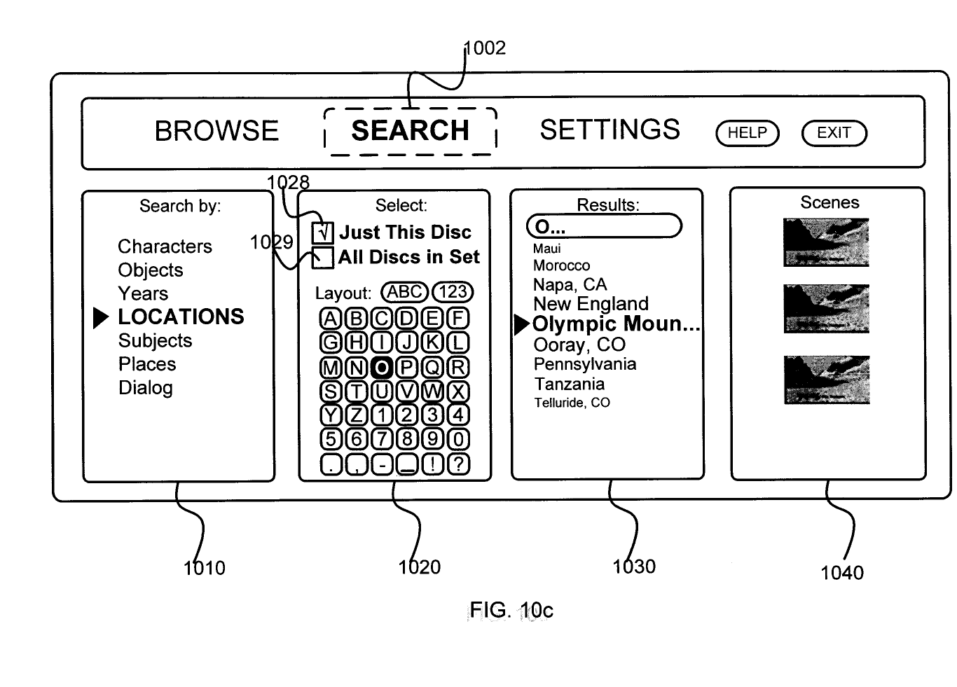

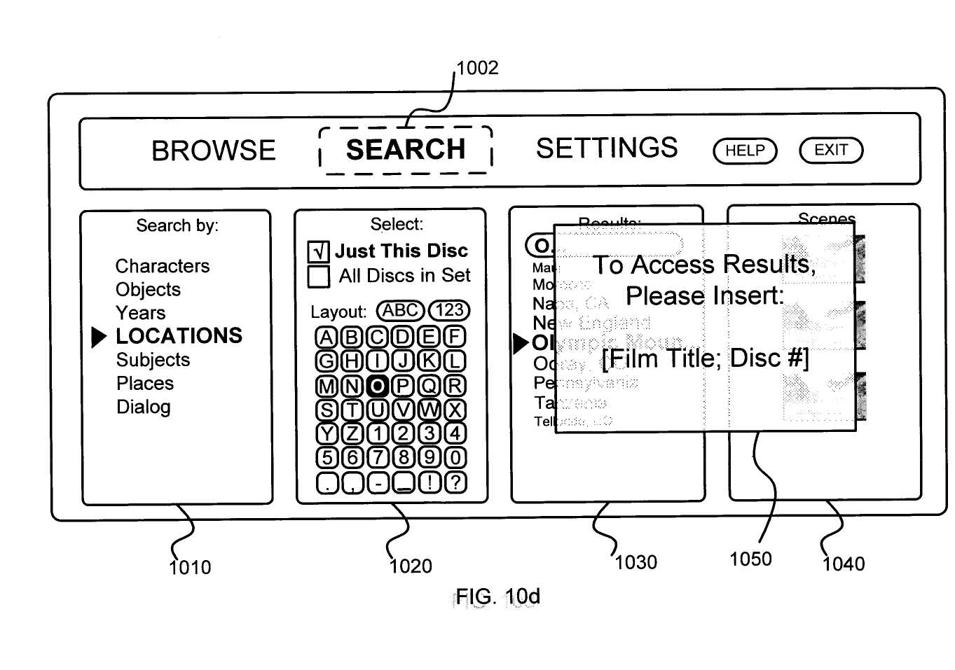

FIGS. 10a, 10b, 10c and 10d are screen shots of a GUI illustrating other alternate processes for enabling a user to search for desired content. The desired content may be located locally (e.g., on a computer-readable medium) or remotely (e.g., on online servers). For example, a user can search for an ordered sequence of digital content, such as scenes of a movie, television series episodes, music tracks, or any segmented array of digital content. Alternatively, a user can search for supplemental content, such as interactive applications, director's commentaries, games, soundtracks, trailers, etc.

The screen shots of the GUI show multiple screen portions 1010, 1020, 1030, 1040 and 1050. In a first screen portion 1010, various search categories are displayed and presented to a user. The search categories become available for display once the user activates search functions by selecting a SEARCH interface object 1002 (e.g., a button.) The available search categories displayed and presented to the user are customized for a particular content (e.g., a movie.) For example, FIG. 10a illustrates presenting search categories that include “CHARACTERS”, “OBJECTS”, “YEARS”, “LOCATIONS”, “SUBJECTS”, “PLACES” and “DIALOG”. Depending on the content, other search categories, such as “SPELL”, “ACTOR”, “OBJECT”, “HOUSE” and “TIME”, can also be displayed and presented to the user.

When the user selects one of the presented search categories, a visual appearance of the selected search category is modified to indicate the user selection. For example, FIG. 10a shows the user selected search category, “LOCATIONS” displayed using a font that is larger than other non-selected categories. In addition, the visual appearance of the category “LOCATIONS” can be further modified by using a font color different from the non-selected categories. Further, a special visual object (e.g., a text character, a symbol, a numeral, an image, etc.) can be displayed next to the user selected category to further indicate user selection. For example, FIG. 10a shows a triangle displayed with one of its vertices pointed toward the selected category, “LOCATIONS”. Alternatively, other visual indicators, such as highlights, shadows, etc. can also be implemented.

A second display portion 1020 includes a keypad-like interface 1022 for enabling the user to select a search term that corresponds to the selected search category. The keypad-like interface 1022 includes user selectable objects (e.g., buttons) that represent one or more text characters (e.g., letters of the alphabet) and/or numerals. While FIG. 10a shows each selector (e.g., button) in the keypad-like interface 1022 representing a single text character, each button can also be implemented to represent multiple characters. Keypad selectors 1024 and 1026 can be used to change the keypad-like interface 1022. For example, a user selection of the keypad selector 1024 modifies the second display portion 1020 to display a standard keypad as shown in FIG. 10a. Alternatively, a user selection of keypad selector 1026 modifies the second display portion 1020 to display an alphanumeric keypad 1028 as shown in FIG. 10b. The user can select the appropriate keypad to closely match the user selectable elements on a control device, such as a remote control device and a mobile computing device (e.g., a mobile phone, a smart phone, a PDA, etc.) For example, when a full keypad is provided on the control device, the standard keypad can be selected. Alternatively, when a alphanumeric keypad is present on the control device, the alphanumeric keypad can be selected.

When using the alphanumeric keypad, T9 functions (e.g., predictive typing) can be implemented to minimize button presses when entering a particular search term corresponding to the user selected search category. Predictive typing can also be provided for the standard keypad. For example, FIG. 10b shows that a user need not enter a complete spelling of the search category name. When sufficiently enough number of letters are entered by the user, the possible matching results are shown in a third display portion 1030. The number of letters needed to be entered by the user before finding the desired result depends on whether common letters are present among various available results. In the example shown in FIG. 10a, a user selection of a single text character, “O”, is illustrated. The user selection of the text character, “O”, is visually indicated using methods described with respect to the first display region 1010.

In the third display region 1030, a LOCATION category name, “OLYMPIC MOUN . . . ” is automatically selected in response to user input of the text character, “O”. The user selection in the third display portion 1030 is visually indicated using methods described with respect to display portions 1010 and 1020. When two or more available results share one or more text characters, additional text characters need to be entered by the user to automatically select the desired result. For example, when the user desires to select the LOCATIONS name, “OORAY, CO”, the user needs to enter two text characters “Oo” in order to automatically select “OORAY, CO”. Alternatively, the user may select the first text character “O” to bring up two possible results, “OLYMPIC MOUN” and “OORAY, CO.” Then, the user can manually select the LOCATIONS name, “OORAY, CO” without entering the second text character, “o”.

Once the desired result has been selected, (e.g., LOCATIONS name, “OORAY, CO”), a fourth display portion 1040 automatically displays all digital content associated with “OORAY, CO.” While FIGS. 10a and 10b shows the fourth display portion 1040 having three display positions, the number of display positions can be increased or decreased. In addition, when the number of digital content available exceeds the maximum number of display positions (e.g., three as shown in FIGS. 10a and 10b), the additional available digital content can be displayed and presented to a user by rotating them through the display positions using techniques described with respect to FIGS. 1-6.

FIG. 10c illustrates enabling searches within a single source or across multiple sources of decoded digital files. A decoded digital file can include a movie located locally on a computer-readable medium (e.g., a disc) or remotely at a online server. The second display portion 1020 can include user selectable objects (e.g., buttons) 1028 and 1029 that enable the user to search within one disc or multiple discs respectively. Searching within multiple discs can be implemented for a single-disc media players and/or multi-disc media players. In both single-disc and multi-disc media players, a user may be prompted to insert a particular computer-readable medium (e.g., a DVD-disc) when the desired disc is not already present in the media player. FIG. 10d shows a fifth display portion 1050 that instructs the user to insert a particular disc that contains the desired digital content.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Further, other embodiments may be within the scope of the disclosure including the following claims.

What is claimed is:

1. A method comprising:
displaying a predetermined sequence of a plurality of introductory digital content, the predetermined sequence minimizing a delay before a main digital content is displayed;
loading a graphical user interface during a time of displaying a first introductory digital content from the predetermined sequence of the plurality of introductory digital content; and
enabling a user to access the loaded graphical user interface while the displaying of the predetermined sequence of the plurality of introductory digital content is pending.

2. The method of claim 1, wherein displaying the main digital content comprises displaying a movie.

3. The method of claim 1, wherein the displaying the plurality of introductory digital content comprises displaying two or more selected from a group including a studio identification trailer, a movie trailer, a commercial, and a copyright warning message.

4. The method of claim 1, wherein the displaying the predetermined sequence of the plurality of introductory digital content comprises displaying a predetermined sequence of a plurality of introductory digital content stored on a machine readable medium.

5. The method of claim 4, wherein the displaying the predetermined sequence of the plurality of introductory digital content stored on the machine readable medium comprises displaying a predetermined sequence of a plurality of introductory digital content stored on one chosen from a group that includes a Blu-ray disc (BD), a digital video disc (DVD) and a high definition DVD disc (HD DVD).

6. The method of claim 1, wherein the displaying the main digital content comprises automatically displaying the main digital content without a user interaction and while the displaying of the plurality of introductory digital content is pending.

7. The method of claim 1, wherein enabling the user to access the loaded graphical user interface comprises enabling the user to start displaying the main digital content while the displaying of the predetermined sequence of the plurality of introductory digital content is pending.

8. The method of claim 1, wherein displaying the predetermined sequence of the plurality of introductory content further comprises displaying a help tutorial to the user.

9. The method of claim 1, wherein enabling a user to access the loaded graphical user interface while the displaying of the predetermined sequence of the plurality of introductory digital content is pending comprises enabling the user to access the loaded graphical user interface before completing the displaying of the predetermined sequence of the plurality of introductory digital content.

10. A computer program product, embodied on a machine readable medium, operable to cause a data processing apparatus to perform operations comprising:
displaying a predetermined sequence of a plurality of introductory digital content, the predetermined sequence minimizing a delay before a main digital content is displayed;
loading a graphical user interface during a time of displaying a first introductory digital content from the predetermined sequence of the plurality of introductory digital content; and
enabling a user to access the loaded graphical user interface while the displaying of the predetermined sequence of the plurality of introductory digital content is pending.

11. The computer program product of claim 10, further operable to cause a data processing device to enable a user to access the loaded graphical user interface while the displaying of the predetermined sequence of the plurality of introductory digital content is pending comprising enabling the user to access the loaded graphical user interface before completing the displaying of the predetermined sequence of the plurality of introductory digital content.

12. A system comprising:
a user interface; and
one or more data processing devices configured to display a graphical user interface for enabling a user navigation of a plurality of digital content, the graphical user interface comprising:
a first display area displaying a visual representation of a plurality of available user input functions, the visual representation providing guidance to a user for each of the available input functions; and
a second display area that displays a visual representation of a result of a user selection of one or more of the available user input functions, wherein a user selection of one of the available user input functions changes the visual representation in the first display area.

13. The system of claim 12, wherein the first display area is configured to activate and deactivate in response to a user request.

14. A system comprising:
a user interface; and
one or more data processing devices configured to display a graphical user interface, wherein the graphical user interface includes
a content display region that includes two or more display positions, wherein each display position is configured to display a visual representation of an ordered sequence of digital content scrolled through the display positions, and wherein one of the display positions is further configured to enable user selection of one of the ordered sequence of digital content.

15. The system of claim 14, wherein the ordered sequence of digital content comprises at least one from a group that includes an ordered sequence of movie scenes, television series episodes, music tracks, and segmented array of digital content.

16. The system of claim 14, wherein the visual representation of the ordered sequence of digital content is arranged in a loop.

17. The system of claim 14, wherein the display positions are further configured to display the visual representation of the ordered sequence of digital content scrolled through the display positions in a forward direction and a reverse direction.

18. The system of claim 14, wherein the content display region further comprises a range selector configured to enable user selection of a range of the ordered sequence of digital content displayed.

19. A method comprising:
displaying a visual representation of an ordered sequence of digital content scrolled through a plurality of display positions, wherein the displaying includes
displaying a visual representation of a first one of the ordered sequence in a first display position;
displaying a visual representation of a second one of the ordered sequence in a second display position;
displaying a visual representation of a third one of the ordered sequence in a third display position, wherein the second display position is located between the first and third display positions;
when a desired one of the ordered sequence of digital content is displayed in the second display position, enabling a user selection of the digital content displayed in the second display position;
when the desired one of the ordered sequence of digital content is displayed in the first display position, scrolling the ordered sequence in a forward direction including
relocating the visual representation of the second one of the ordered sequence of digital content from the second display position to the third display position, and
relocating the visual representation of the first one of the ordered sequence of digital content from the first display position to the second display position; and
when the desired one of the ordered sequence of digital content is displayed in the third display position, scrolling the ordered sequence in a reverse direction including
relocating the visual representation of the second one of the ordered sequence of digital content from the second display position to the first display position, and
relocating the visual representation of the third one of the ordered digital content from the third display position to the second display position.

20. A system comprising:
a user interface; and
one or more data processing devices configured to display a graphical user interface comprising:
a search category display area operable to display a plurality of user selectable search categories;
a search input area operable to receive user input corresponding to a user selected search category;
a search results display area operable to display one or more search results based on the received user input, wherein the displayed search results are dynamically modified in response to the received user input; and
a content display area operable to display a visual representation of one or more digital content corresponding to one of the displayed search results.

21. A system of claim 20 wherein the displayed graphical user interface further comprises a help display area operable to provide guidance to a user.

22. A system of claim 20, wherein the user selectable search categories comprises two or more selected from a group that includes actors, characters, dialogue, locations, spelling, objects, house, places and time.

23. A system of claim 20, wherein the user selected category is displayed using a visual indication different from non-selected categories.

24. A system of claim 20, wherein the search input area further comprises a selector that enables a user to access one of a keypad and an alphanumeric pad.

25. A system of claim 20, wherein at least one of the keypad and the alphanumeric pad is configured to provide predictive typing.

26. A system comprising:
a user interface; and
one or more data processing devices configured to display a graphical user interface comprising
a plurality of user selectable elements; and
a plurality of status indicators displayed adjacent to the plurality of user selectable elements, wherein each of the plurality of status indicators are dynamically modified based on a user selection of one of the user selectable elements.

27. The system of claim 26, wherein the plurality of status indicators are displayed using one or more natural language terms.
